(19) United States
(12) Patent Application Publication
(10) Pub. No.: US 2021/0208481 A1
(43) Pub. Date: Jul. 8, 2021

(54) OBSERVATION OPTICAL SYSTEM AND OPTICAL APPARATUS

(71) Applicant: FUJIFILM Corporation, Tokyo (JP)

(72) Inventor: Shunsuke MIYAGISHIMA, Saitama (JP)

(73) Assignee: FUJIFILM Corporation, Tokyo (JP)

(21) Appl. No.: 17/131,958

(22) Filed: Dec. 23, 2020

(30) Foreign Application Priority Data
Dec. 25, 2019 (JP) 2019-234541

(51) Int. Cl. G03B 13/06; G02B 15/14; G02B 13/18

(52) U.S. Cl. CPC G03B 13/06; G02B 13/18; G02B 15/143105

(57) ABSTRACT

An observation optical system including: a display element; and an eyepiece lens disposed on an eye point side of the display element, wherein the eyepiece lens consists of, in order from a display element side toward the eye point side, a first lens having a positive refractive power, a second lens having a negative refractive power, and a third lens having a positive refractive power, and in a case where a longest diameter of a display area in the display element is H, and a focal length of the eyepiece lens is fA, a conditional expression (1) is satisfied:

0.7<H/fA<0.8 (1).

### CROSS-REFERENCE TO RELATED APPLICATIONS

The present application claims priority under 35 U.S.C. § 119 to Japanese Patent Application No. 2019-234541, filed on Dec. 25, 2019. The above application is hereby expressly incorporated by reference, in its entirety, into the present application.

### BACKGROUND

### Technical Field

The present disclosure relates to an observation optical system and an optical apparatus.

### Related Art

Hitherto, in a view finder of an imaging apparatus, such as a digital camera, an observation optical system that is provided for observing an image displayed on a display element, such as a liquid crystal display element, is used. JP2015-135471A, JP5745186B, JP2019-133055A, JP2011-085872A, JP6436680B, JP2016-166969A, and JP5886707B describe a lens system that is usable as an observation optical system.

In recent years, there is demand for an observation optical system capable of achieving further reduction in size and a high finder magnification.

### SUMMARY

The present disclosure has been accomplished in consideration of the above circumstances, and an object of the present disclosure is to provide an observation optical system, in which both of reduction in size and a high finder magnification are achieved, and an optical apparatus including the observation optical system.

An observation optical system according to an aspect of the present disclosure includes a display element, and an eyepiece lens disposed on an eye point side of the display element. The eyepiece lens consists of, in order from a display element side toward the eye point side, a first lens having a positive refractive power, a second lens having a negative refractive power, and a third lens having a positive refractive power, and in a case where a longest diameter of a display area in the display element is H, and a focal length of the eyepiece lens is fA, a conditional expression (1) is satisfied.

0.7<H/fA<0.8 (1)

In the observation optical system according to the aspect of the present disclosure, it is preferable that the following conditional expression (1-1) is satisfied. It is more preferable that the following conditional expression (1-2) is satisfied.

0.72<H/fA<0.78 (1-1)

0.735<H/fA<0.77 (1-2)

In the observation optical system according to the aspect of the present disclosure, it is preferable that, in a case where a distance on an optical axis from a display element-side surface of the first lens to an eye point-side surface of the third lens is TL, the following conditional expression (2) is satisfied. It is more preferable that the following conditional expression (2-1) is satisfied.

1.075<TL/fA<1.16 (2)

1.085<TL/fA<1.15 (2-1)

In the observation optical system according to the aspect of the present disclosure, it is preferable that, in a case where an average value of a refractive index of the first lens with respect to d line and a refractive index of the third lens with respect to d line is NdA, the following conditional expression (3) is satisfied. It is more preferable that the following conditional expression (3-1) s satisfied.

1.64<NdA<1.8 (3)

1.65<NdA<1.79 (3-1)

In the observation optical system according to the aspect of the present disclosure, it is preferable that, in a case where a focal length of the first lens is f1, the following conditional expression (4) is satisfied. It is more preferable that the following conditional expression (4-1) is satisfied.

0.63<f1/fA<0.75 (4)

0.64<f1/fA<0.74 (4-1)

In the observation optical system according to the aspect of the present disclosure, it is preferable that, in a case where a focal length of the second lens is f2, the following conditional expression (5) is satisfied. It is more preferable that the following conditional expression (5-1) is satisfied.

0.62<−f2/fA<0.77 (5)

0.63<−f2/fA<0.76 (5-1)

In the observation optical system according to the aspect of the present disclosure, it is preferable that each of the first lens, the second lens, and the third lens is a single lens.

In the observation optical system according to the aspect of the present disclosure, it is preferable that the first lens is a biconvex lens.

In the observation optical system according to the aspect of the present disclosure, it is preferable that the second lens is a biconcave lens.

In the observation optical system according to the aspect of the present disclosure, it is preferable that the third lens is a biconvex lens.

In the observation optical system according to the aspect of the present disclosure, it is preferable that at least one surface of the first lens is an aspheric surface.

In the observation optical system according to the aspect of the present disclosure, it is preferable that at least one surface of the second lens is an aspheric surface.

In the observation optical system according to the aspect of the present disclosure, it is preferable that at least one surface of the third lens is an aspheric surface.

An optical apparatus according to another aspect of the present disclosure includes the observation optical system according to the aspect of the present disclosure.

In the specification, it should be noted that the terms “consisting of ˜” and “consists of ˜” mean that not only the above-described components but also lenses substantially having no refractive power, optical elements, such as a stop, a filter, and a cover glass, other than lenses, and a lens flange, a lens barrel, and the like may be included.

In the specification, it should be noted that the term “single lens” means one uncemented lens. However, a composite aspheric lens (a lens that integrally consists of a spherical lens and a film having an aspheric shape formed on the spherical lens, and functions as one aspheric lens as a whole) is not regarded as a cemented lens, but is treated as a single lens. In regard to a lens including an aspheric surface, a sign of a refractive power and a surface shape of a lens surface are considered in terms of a paraxial region unless otherwise specified.

In the specification, the term “focal length” used in the conditional expressions means a paraxial focal length. The values of the conditional expressions are values that are obtained with respect to d line. “d line”, “C line”, and “F line” described in the specification are emission lines, a wavelength of d line is 587.56 nm (nanometer), a wavelength of C line is 656.27 nm (nanometer), and a wavelength of F line is 486.13 nm (nanometer).

According to the aspects of the present disclosure, it is possible to provide an observation optical system, in which both of reduction in size and a high finder magnification are achieved, and an optical apparatus including the observation optical system.

### BRIEF DESCRIPTION OF THE DRAWINGS

FIG. 1 is a sectional view showing the configuration and an optical path of an observation optical system according to an embodiment (an observation optical system of Example 1).

FIG. 2 is a spherical aberration diagram, an astigmatism diagram, a distortion diagram, and a lateral chromatic aberration diagram of the observation optical system of Example 1.

FIG. 3 is a lateral aberration diagram of the observation optical system of Example 1.

FIG. 4 is a sectional view showing a configuration and an optical path of an observation optical system of Example 2.

FIG. 5 is a spherical aberration diagram, an astigmatism diagram, a distortion diagram, and a lateral chromatic aberration diagram of the observation optical system of Example 2.

FIG. 6 is a lateral aberration diagram of the observation optical system of Example 2.

FIG. 7 is a sectional view showing a configuration and an optical path of an observation optical system of Example 3.

FIG. 8 is a spherical aberration diagram, an astigmatism diagram, a distortion diagram, and a lateral chromatic aberration diagram of the observation optical system of Example 3.

FIG. 9 is a lateral aberration diagram of the observation optical system of Example 3.

FIG. 10 is a diagram showing a hardware configuration of an optical apparatus according to an embodiment.

FIG. 11 is a diagram showing an example of a correction table.

FIG. 12 is a diagram showing a functional configuration of an optical apparatus according to an embodiment.

### DESCRIPTION OF EMBODIMENTS

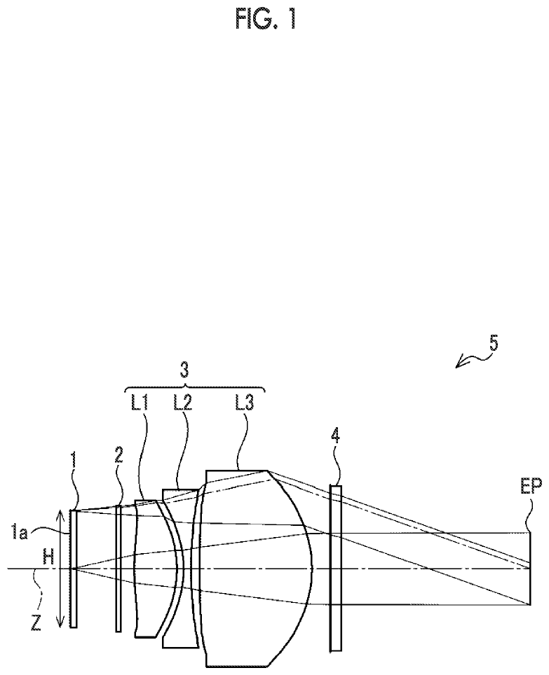

Hereinafter, an embodiment of the present disclosure will be described in detail referring to the drawings. FIG. 1 is a diagram showing a configuration and an optical path of an observation optical system 5 according to an embodiment of the present disclosure on a cross section including an optical axis Z, and corresponds to a lens configuration of Example 1 described below. In an example shown in FIG. 1, a display element 1 is used as an observation object, and a luminous flux directed from a point on the optical axis on the display element 1 and a luminous flux directed from a highest point on the display element 1 toward an eye point EP are shown together. The eye point EP shown in FIG. 1 does not indicate a size and a shape, but indicates a position in the direction of the optical axis. In FIG. 1, the left side is shown as an observation object side, and the right side is shown as an eye point side.

The observation optical system 5 of the embodiment comprises a display element 1, and an eyepiece lens 3 disposed on the eye point side of the display element 1. The display element 1 includes a display area 1a where an image is displayed. As the display element 1, for example, an image display element, such as a liquid crystal display element and an organic electro luminescence (EL) display element, can be exemplified. The eyepiece lens 3 is usable in magnifying and observing an image displayed on the display area 1a of the display element 1. In the example of FIG. 1, optical members 2 and 4 of which the incidence surface and the emission surface are parallel to each other and which have no refractive power are disposed between the display element 1 and the eyepiece lens 3 and between the eyepiece lens 3 and the eye point EP, respectively. The optical members 2 and 4 are assumed to be protective cover glass, various filters, or the like, and in the embodiment, a configuration can also be made in which the optical members 2 and 4 are excluded.

The eyepiece lens 3 consists of, in order from the observation object side toward the eye point side along the optical axis Z, a first lens L1 having a positive refractive power, a second lens L2 having a negative refractive power, and a third lens L3 having a positive refractive power. As the eyepiece lens 3 consists of the three lenses, a triplet configuration is made, and control of aberrations is facilitated. Furthermore, as the eyepiece lens 3 has the triplet configuration, it is possible to shorten a length in the direction of the optical axis from a most observation object-side lens surface to a most eye point-side lens surface of the eyepiece lens 3 compared to a configuration in which the eyepiece lens consists of four or more lenses, and thus, it is advantageous in reduction in size.

It is preferable that each of the first lens L1, the second lens L2, and the third lens L3 is a single lens. With such a configuration, it is possible to increase a degree of freedom of design, and thus, it is advantageous in correcting aberrations.

It is preferable that the first lens L1 is a biconvex lens. As the first lens L1 is formed as a biconvex lens, it is possible to increase a refractive power, and it is advantageous in reduction in size. As an eye point-side surface of the first lens L1 is formed as a convex surface, it is advantageous in correcting distortion generated in a lens closer to the eye point side than the first lens L1. It is preferable that at least one surface of the first lens L1 is an aspheric surface. As at least one surface of the first lens L1 is formed as an aspheric surface, it is possible to facilitate correction of astigmatism, high-order spherical aberration, and distortion.

It is preferable that the second lens L2 is a biconcave lens. As the second lens L2 is formed as a biconcave lens, it is possible for the second lens L2 to have a strong negative refractive power, and thus, it is advantageous in securing a sufficient view angle and it is advantageous in correcting aberrations, such as coma aberration and field curvature. It is preferable that at least one surface of the second lens L2 is an aspheric surface. As at least one surface of the second lens L2 is formed as an aspheric surface, it is possible to facilitate correction of astigmatism, high-order spherical aberration, and distortion.

It is preferable that the third lens L3 is a biconvex lens. As the third lens L3 is formed as a biconvex lens, it is possible to increase a refractive power, and it is advantageous in reduction in size. As an eye point-side surface of the third lens L3 is formed as a convex surface, it is advantageous in correcting spherical aberration. It is preferable that at least one surface of the third lens L3 is an aspheric surface. As at least one surface of the third lens L3 is formed as an aspheric surface, it is possible to facilitate correction of astigmatism, high-order spherical aberration, and distortion.

The observation optical system 5 of the present disclosure is configured such that, in a case where a longest diameter of the display area 1a in the display element 1 is H, and a focal length of the eyepiece lens 3 is fA, the following conditional expression (1) is satisfied. As a value of the conditional expression (1) is set to be not equal to or less than a lower limit, it is possible to suppress an observation size of an image displayed on the display area 1a of the display element 1 from being small, and thus, it is advantageous in achieving a high finder magnification. As the value of the conditional expression (1) is set to be not equal to or greater than an upper limit, correction of coma aberration is facilitated. In order to obtain more satisfactory characteristics, it is preferable that the following conditional expression (1-1) is satisfied. It is more preferable that the following conditional expression (1-2) is satisfied.

0.7<H/fA<0.8 (1)

0.72<H/fA<0.78 (1-1)

0.735<H/fA<0.77 (1-2)

The term “the longest diameter of the display area 1a in the display element 1” means a value twice as much as a distance between a point farthest from the optical axis Z and the optical axis Z in a radial direction in the display area 1a of which the center of gravity coincides with the optical axis Z. For example, in a case where the display area 1a is rectangular, the length of a diagonal of the display area 1a can be set to H. Furthermore, for example, in a case where the display area 1a is a perfect circle, the diameter of the display area 1a can be set to H, and in a case where the display area 1a is an ellipse, the longest diameter (long diameter) between the diameters of the display area 1a can be set to H.

The display area 1a means an area where an image is actually displayed. For example, the display element 1 comprises a display unit with an aspect ratio of 4:3 in which a plurality of pixels are arranged, and an image of an aspect ratio of 3:2 is displayed in a part of the display unit, the display area 1a indicates an area where the image with the aspect ratio of 3:2 is displayed. Accordingly, the diameter of the display element 1 and the longest diameter H of the display area 1a are not limited to a form in which both coincide with each other as in the example of FIG. 1, and may be different from each other.

In the observation optical system 5 of the present disclosure, it is preferable that, in a case where a distance on the optical axis from a display element-side surface of the first lens L1 to an eye point-side surface of the third lens L3 is TL, the following conditional expression (2) is satisfied. As a value of the conditional expression (2) is set to be not equal to or less than a lower limit, it is advantageous in securing a diopter adjustment width and correcting coma aberration. As the value of the conditional expression (2) is set to be not equal to or greater than an upper limit, it is advantageous in reduction in size in the direction of the optical axis Z. In order to obtain more satisfactory characteristics, it is preferable that the following conditional expression (2-1) is satisfied.

1.075<TL/fA<1.16 (2)

1.085<TL/fA<1.15 (2-1)

In the observation optical system 5 of the present disclosure, it is preferable that, in a case where an average value of a refractive index of the first lens L1 with respect to d line and a refractive index of the third lens L3 with respect to d line is NdA, the following conditional expression (3) is satisfied. As a value of the conditional expression (3) is set to be not equal to or less than a lower limit, it is possible to make a Petzval sum small, and it is advantageous in suppressing field curvature. As the value of the conditional expression (3) is set to be not equal to or greater than an upper limit, it is possible to select a material having an appropriate Abbe number, and it is advantageous in correcting chromatic aberration. In order to obtain more satisfactory characteristics, it is preferable that the following conditional expression (3-1) is satisfied.

1.64<NdA<1.8 (3)

1.65<NdA<1.79 (3-1)

In the observation optical system 5 of the present disclosure, it is preferable that, in a case where a focal length of the first lens L1 is f1, the following conditional expression (4) is satisfied. As a value of the conditional expression (4) is set to be not equal to or less than a lower limit, it is possible to suppress an excessive increase in refractive power of the first lens L1, and it is advantageous in correcting distortion. As a value of the conditional expression (4) is set to be not equal to or greater than an upper limit, it is possible to suppress a decrease in refractive power of the first lens L1. Thus, it is possible to suppress an increase in interval between the first lens L1 and the second lens L2, and it is advantageous in reduction in size in the direction of the optical axis Z. In order to obtain more satisfactory characteristics, it is preferable that the following conditional expression (4-1) is satisfied.

0.63<f1/fA<0.75 (4)

0.64<f1/fA<0.74 (4-1)

In the observation optical system 5 of the present disclosure, it is preferable that, in a case where a focal length of the second lens is f2, the following conditional expression (5) is satisfied. As a value of the conditional expression (5) is set to be not equal to or less than a lower limit, it is possible to suppress an excessive increase in refractive power of the second lens L2, and it is advantageous in correcting coma aberration, astigmatism, and field curvature. As the value of the conditional expression (5) is set to be not equal to or greater than an upper limit, it is possible to suppress a decrease in refractive power of the second lens L2, and thus, it is advantageous in securing a sufficient view angle. In order to obtain more satisfactory characteristics, it is preferable that the following conditional expression (5-1) is satisfied.

0.62<−f2/fA<0.77 (5)

0.63<−f2/fA<0.76 (5-1)

The above-described configurations and available configurations may be any combination, and it is preferable that the configurations are suitably selectively employed according to a required specification.

Next, numerical examples of the observation optical system 5 of the present disclosure will be described.

### EXAMPLE 1

Since a sectional view showing a configuration and an optical path of an observation optical system 5 of Example 1 is shown in FIG. 1, and an illustration method thereof is as described above, overlapping description will not be repeated. In regard to the observation optical system 5 of Example 1, basic lens data is shown in Table 1, variable surface distances are shown in Table 2, specifications are shown in Table 3, and aspheric coefficients are shown in Table 4.

In Table 1, a column of Sn shows a surface number in a case where an observation object-side surface of the display element 1 (a surface on which the display area 1a is disposed) is regarded as a first surface and the number increases one by one toward the eye point side. In Table 1, the display element 1, the optical members 2 and 4, and the eye point EP are also described, and the surface number and text reading (EP) are described in the column of Sn of a surface corresponding to the eye point EP. A column of R shows a radius of curvature of each surface, a sign of a radius of curvature of a surface convex toward the observation object side is positive, and a sign of a radius of curvature of a surface convex toward the eye point side is negative. A mark * is attached to the surface number of an aspheric surface, and a numerical value of a paraxial radius of curvature is described in the column of the radius of curvature of the aspheric surface.

In Table 1, a column of D shows a surface distance on the optical axis Z between each surface and an adjacent surface on the eye point side, and the variable surface distance during diopter adjustment is referenced by a symbol dd[ ] and is described in the column of D where the surface number of the distance on the observation object side is noted [ ]. A column of Nd shows a refractive index of each component with respect to d line. A column of vd shows an Abbe number of each component with respect to d line.

Table 2 shows values of variable surface distances for each diopter. In Table 2, “dpt” means a diopter. In the observation optical system 5 of Example 1, diopter adjustment can be performed within a range of −4 dpt to +2 dpt by integrally moving the eyepiece lens 3 in the direction of the optical axis Z.

Table 3 shows values of the focal length fA of the eyepiece lens 3, the longest diameter H of the display area 1a in the display element 1, and a finder magnification. The values shown in Table 3 are values in a case where the diopter is −1 dpt. The finder magnification is a finder magnification with respect to an imaging element of a full size (24 mm (millimeter) x 36 mm (millimeter)) in a case where an imaging lens having a focal length of 50 mm (millimeter) is mounted.

In Table 4, a column of Sn shows the surface number of the aspheric surface. Columns of KA and Am (where m is an integer equal to or greater than 3, and is different depending on the surface) show numerical values of aspheric coefficients of each aspheric surface. “E±n” (where n is an integer) in the numerical values of the aspheric coefficients means “×10^{±n}”. KA and Am are the aspheric coefficients in an aspheric surface expression described below.

Zd=C×h²/{1+(1−KA×C²×h²)^{1/2}}+ΣAm×h^{m}

Here,

Zd: an aspheric surface depth (a length of a vertical line from a point on an aspheric surface at a height h to a plane perpendicular to the optical axis and in contact with an aspheric surface apex)

h: a height (a distance from the optical axis to the lens surface)

C: a paraxial curvature

KA, Am: aspheric coefficients, and

Σ in the aspheric surface expression means the sum with respect to m.

Hereinafter, in data of the tables and the drawings, although degree is used as a unit of an angle, and mm (millimeter) is used as a unit of a length, other appropriate units may be used since optical systems are usable even though the optical systems are proportionally magnified or proportionally reduced. In the following tables, numerical values are rounded to a predetermined digit.

TABLE 1
Example 1

| Sn | R | D | Nd | νd |
|---|---|---|---|---|
| 1 | ∞ | 0.7000 | 1.51680 | 64.20 |
| 2 | ∞ | 4.3000 | | |
| 3 | ∞ | 0.5000 | 1.49023 | 57.49 |
| 4 | ∞ | dd[4] | | |
| *5 | 29.9250 | 4.5786 | 1.80552 | 46.51 |
| *6 | −11.8637 | 0.7550 | | |
| *7 | −11.7233 | 0.8000 | 1.83687 | 23.16 |
| *8 | 43.8550 | 0.9092 | | |
| *9 | 79.5741 | 12.2829 | 1.73807 | 54.19 |
| *10 | −13.3544 | dd[10] | | |
| 11 | ∞ | 1.2000 | 1.49023 | 57.50 |
| 12 | ∞ | 20.6000 | | |
| 13(EP) | ∞ | | | |

TABLE 2
Example 1

| Diopter | +2 dpt | −1 dpt | −4 dpt |
|---|---|---|---|
| dd[4] | 2.4893 | 1.4873 | 0.4854 |
| dd[10] | 0.9980 | 2.0000 | 3.0020 |

TABLE 3
Example 1

| | |
|---|---|
| fA | 17.05 |
| H | 12.81 |
| Finder | 0.83 |
| Magnification | |

TABLE 4
Example 1

| Sn | 5 | | 6 | |
|---|---|---|---|---|
| KA | 1.0000000E+00 | | 1.0000000E+00 | |
| A3 | 6.9216316E−04 | | 4.8506862E−04 | |
| A4 | −3.2171020E−04 | | 1.0056522E−04 | |
| A5 | −3.2993820E−05 | | −7.3476840E−05 | |
| A6 | 1.5313698E−05 | | 2.0929413E−05 | |
| A7 | −1.4947398E−06 | | −1.8972398E−06 | |
| A8 | −1.5590193E−07 | | −6.9349964E−08 | |
| A9 | −6.3861916E−09 | | −2.2661059E−08 | |
| A10 | 4.6034657E−09 | | 6.5489130E−09 | |
| A11 | −8.0493375E−11 | | 1.8478622E−10 | |
| A12 | −6.5592997E−11 | | 2.1377768E−12 | |
| A13 | 9.6124067E−12 | | −5.6211993E−12 | |
| A14 | 1.5079980E−12 | | −2.5420101E−13 | |
| A15 | −2.6005121E−14 | | −5.5311989E−14 | |
| A16 | −3.5918844E−14 | | 2.8423269E−15 | |
| A17 | −1.1490078E−15 | | −1.3915850E−16 | |
| A18 | 4.4197799E−17 | | 8.4020502E−17 | |
| A19 | 2.7174300E−18 | | 2.0061156E−17 | |
| A20 | 3.3240781E−18 | | −2.1682810E−18 | |
| Sn | 7 | 8 | 9 | 10 |
| KA | 1.0000000E+00 | 1.0000000E+00 | 1.0000000E+00 | 1.0000000E+00 |
| A4 | 1.3899615E−04 | −2.7023970E−05 | −4.9310076E−05 | 2.1362106E−05 |
| A6 | −1.8644415E−06 | 1.1995181E−06 | 1.7542443E−07 | 2.2724185E−09 |
| A8 | 4.9573857E−08 | −2.3734790E−08 | 8.6803823E−09 | 2.4857547E−09 |
| A10 | 1.3976821E−09 | −3.0549515E−11 | 5.7656500E−11 | −1.6958512E−11 |
| A12 | −2.0973660E−11 | 3.5870389E−12 | −6.5413266E−13 | −1.8228669E−13 |
| A14 | −5.6454084E−13 | 4.3983495E−14 | −7.1906207E−15 | 4.2807141E−15 |
| A16 | −3.4110745E−15 | −1.1538080E−15 | 5.9862936E−17 | −6.2535493E−18 |
| A18 | 4.2433336E−16 | 2.1087573E−18 | −1.6643714E−19 | −2.4082303E−19 |
| A20 | −4.0821887E−18 | 2.9593585E−20 | 1.0560399E−21 | 1.3492906E−21 |

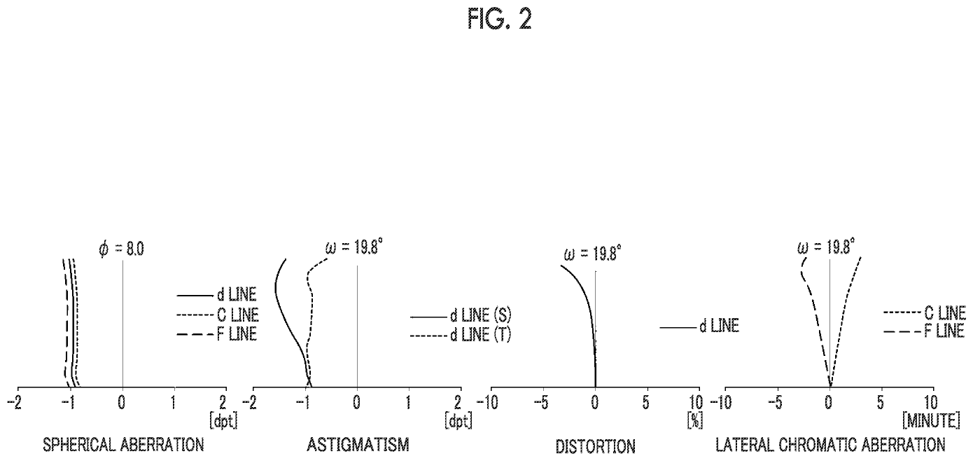

FIG. 2 shows a spherical aberration diagram, an astigmatism diagram, a distortion diagram, and a lateral chromatic aberration diagram of the observation optical system 5 according to Example 1 in a state in which the diopter is −1.00. In the spherical aberration diagram, aberrations with respect to d line, C line, and F line are shown by a solid line, a short dashed line, and a long dashed line, respectively. In the astigmatism diagram, an aberration in a sagittal direction with respect to d line is shown by a solid line, and an aberration in a tangential direction with respect to d line is shown by a short dashed line. In the distortion diagram, an aberration with respect to d line is shown by a solid line. In the lateral chromatic aberration diagram, aberrations with respect to C line and F line are shown by a short dashed line and a long dashed line, respectively. A unit of a horizontal axis in the spherical aberration diagram and the astigmatism diagram is diopter. φ in the spherical aberration diagram means a diameter of an eye point in a case where a unit is mm (millimeter), and ω in other aberration diagrams means a view angle at a half angle of view.

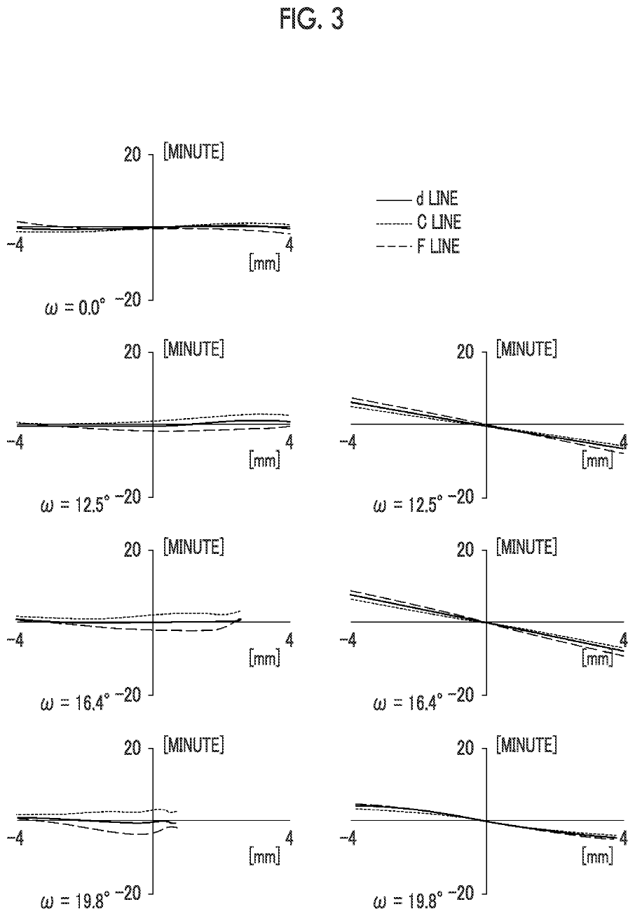

FIG. 3 shows a lateral aberration diagram of the observation optical system 5 according to Example 1 in a state in which the diopter is −1.00. A left column shows the aberrations in the tangential direction for each angle of view, and a right column shows aberrations in the sagittal direction for each angle of view. In FIG. 3, aberrations with respect to d line, C line, and F line are shown by a solid line, a short dashed line, and a long dashed line, respectively. ω of FIG. 3 means a view angle at a half angle of view.

The symbols, the meanings, and the description methods of respective data relating to Example 1 are the same as those in the following examples unless otherwise specified, and thus, hereinafter, overlapping description will not be repeated.

### EXAMPLE 2

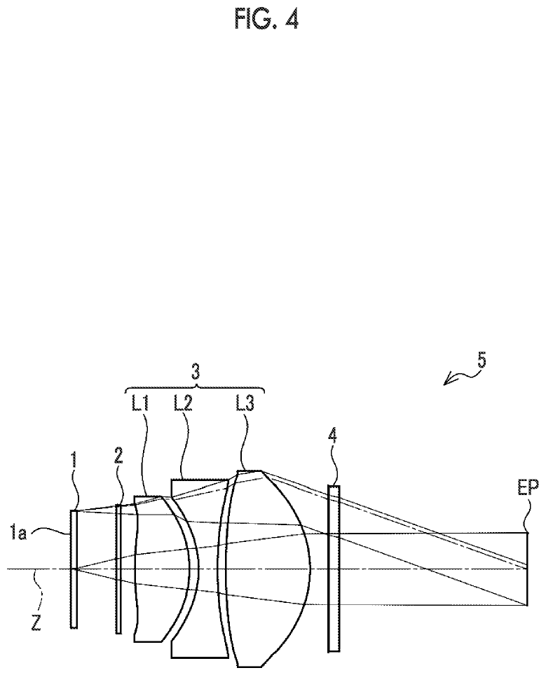

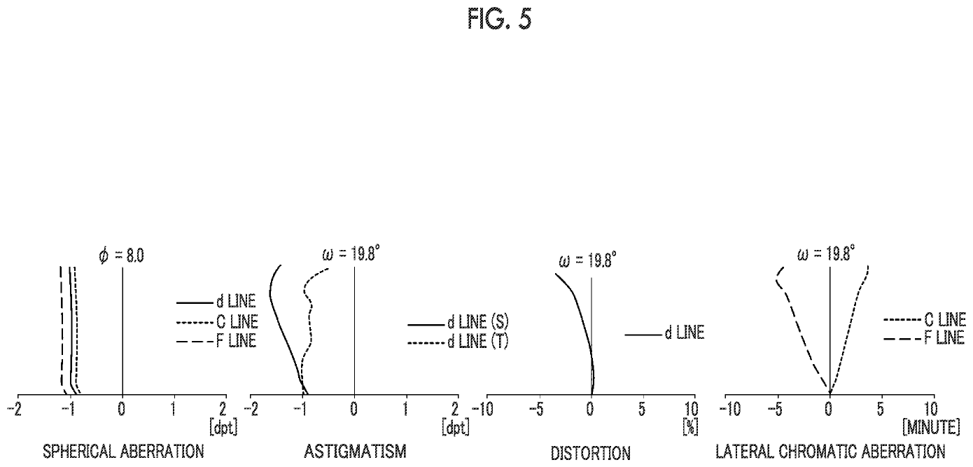

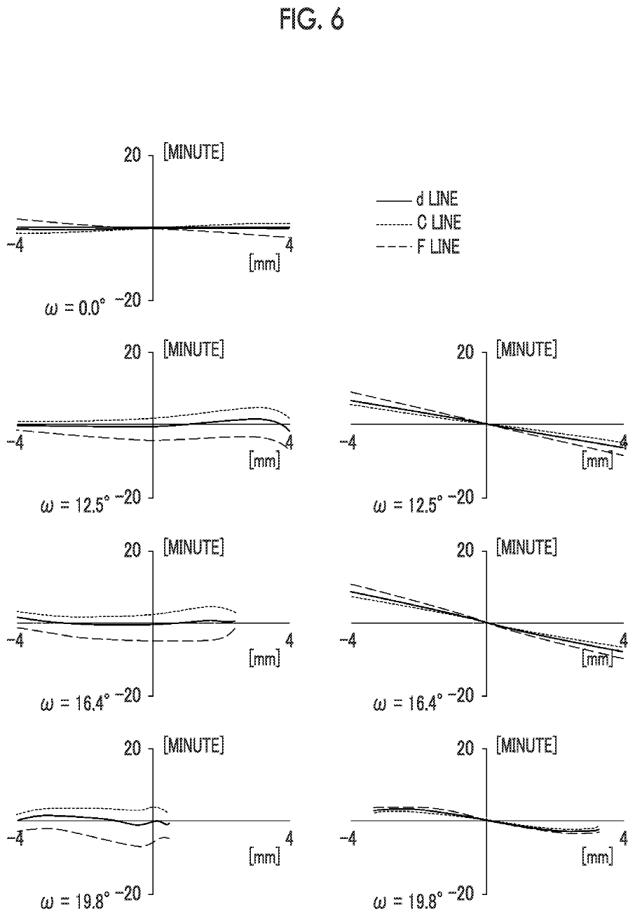

In regard to an observation optical system 5 of Example 2, a sectional view of a configuration and an optical path is shown in FIG. 4, aberration diagrams are shown in FIG. 5, and a lateral aberration diagram is shown in FIG. 6. In regard to the observation optical system 5 of Example 2, basic lens data is shown in Table 5, variable surface distances are shown in Table 6, specifications are shown in Table 7, and aspheric coefficients are shown in Table 8.

TABLE 5
Example 2

| Sn | R | D | Nd | νd |
|---|---|---|---|---|
| 1 | ∞ | 0.7000 | 1.51680 | 64.20 |
| 2 | ∞ | 4.3000 | | |
| 3 | ∞ | 0.5000 | 1.49023 | 57.49 |
| 4 | ∞ | dd[4] | | |
| *5 | 27.0386 | 6.0000 | 1.69569 | 56.72 |
| *6 | −11.2818 | 0.9960 | | |
| *7 | −10.9941 | 2.0824 | 1.67775 | 31.59 |
| *8 | 42.2252 | 0.9000 | | |
| *9 | 63.8196 | 9.1762 | 1.63648 | 59.68 |
| *10 | −12.0790 | dd[10] | | |
| 11 | ∞ | 1.2000 | 1.49023 | 57.50 |
| 12 | ∞ | 20.6000 | | |
| 13(EP) | ∞ | | | |

TABLE 6
Example 2

| Diopter | +2 dpt | −1 dpt | −4 dpt |
|---|---|---|---|
| dd[4] | 2.5239 | 1.5279 | 0.5320 |
| dd[10] | 1.0040 | 2.0000 | 2.9960 |

TABLE 7
Example 2

| | |
|---|---|
| fA | 16.98 |
| H | 12.81 |
| Finder | 0.84 |
| Magnification | |

TABLE 8
Example 2

| Sn | 5 | | 6 | |
|---|---|---|---|---|
| KA | 1.0000000E+00 | | 1.0000000E+00 | |
| A3 | 6.7931360E−04 | | 2.0130397E−04 | |
| A4 | −4.1911342E−04 | | 1.5418747E−04 | |
| A5 | −2.1370564E−05 | | −8.2575975E−05 | |
| A6 | 1.4238223E−05 | | 2.0586825E−05 | |
| A7 | −1.4947398E−06 | | −1.8972398E−06 | |
| A8 | −1.5590193E−07 | | −6.9349964E−08 | |
| A9 | −6.3861916E−09 | | −2.2661059E−08 | |
| A10 | 4.6034657E−09 | | 6.5489130E−09 | |
| A11 | −8.0493375E−11 | | 1.8478622E−10 | |
| A12 | −6.5592997E−11 | | 2.1377768E−12 | |
| A13 | 9.6124067E−12 | | −5.6211993E−12 | |
| A14 | 1.5079980E−12 | | −2.5420101E−13 | |
| A15 | −2.6005121E−14 | | −5.5311989E−14 | |
| A16 | −3.5918844E−14 | | 2.8423269E−15 | |
| A17 | −1.1490078E−15 | | −1.3915850E−16 | |
| A18 | 4.4197799E−17 | | 8.4020502E−17 | |
| A19 | 2.7174300E−18 | | 2.0061156E−17 | |
| A20 | 3.3240781E−18 | | −2.1682810E−18 | |
| Sn | 7 | 8 | 9 | 10 |
| KA | 1.0000000E+00 | 1.0000000E+00 | 1.0000000E+00 | 1.0000000E+00 |
| A4 | 7.0044628E−05 | −7.7986421E−06 | 2.8165078E−05 | 4.2191814E−05 |
| A6 | −2.3381040E−06 | 1.5668618E−06 | 7.3739130E−08 | 8.4131994E−09 |
| A8 | 4.9581629E−08 | −1.3911791E−08 | 4.8409282E−10 | 3.0131724E−09 |
| A10 | 1.7415233E−09 | −1.0757491E−10 | 2.1303049E−12 | −1.4451463E−11 |
| A12 | −1.3582433E−11 | −1.1385447E−12 | −3.4556919E−13 | −1.1184443E−13 |
| A14 | −6.0419383E−13 | 6.8962261E−14 | 1.8448391E−15 | 3.9140013E−15 |
| A16 | −5.7000808E−15 | −6.4888121E−16 | 5.8675879E−17 | −3.4307541E−18 |
| A18 | 3.5240227E−16 | 1.3440670E−18 | −7.2609314E−19 | −2.6591309E−19 |
| A20 | −2.7050338E−18 | 3.4577392E−21 | 2.3539422E−21 | 1.8020909E−21 |

### EXAMPLE 3

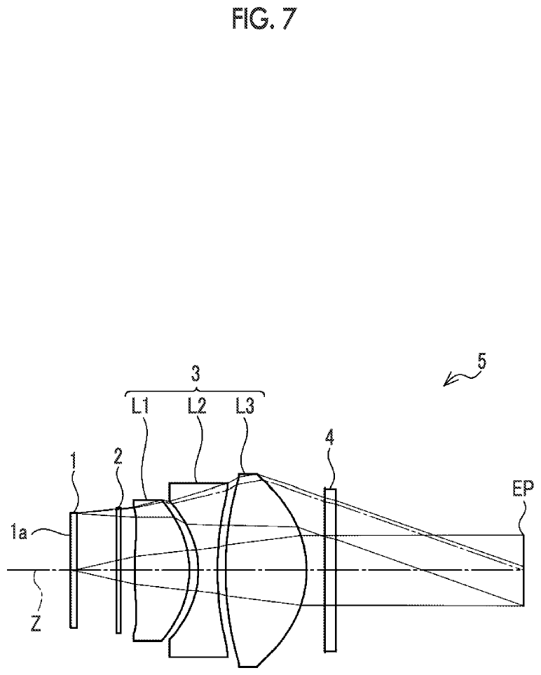

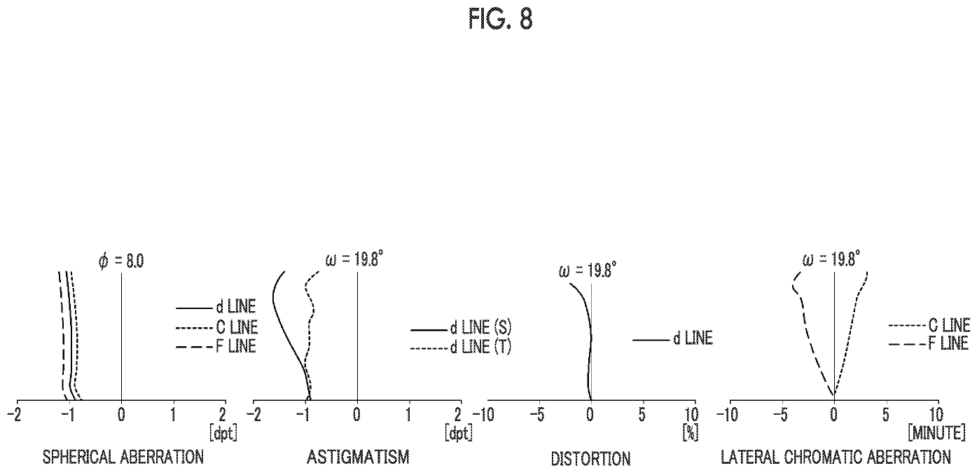

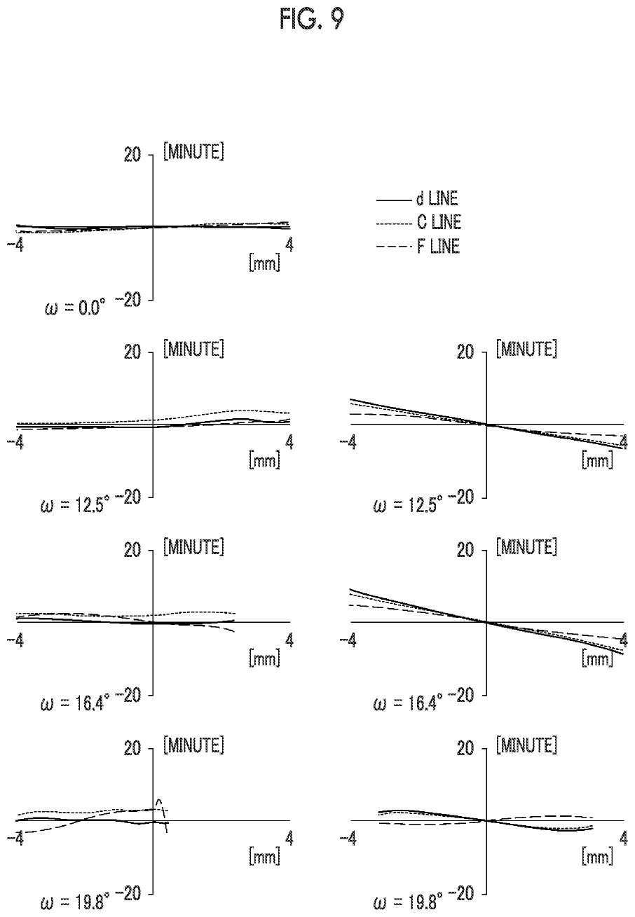

In regard to an observation optical system 5 of Example 3, a sectional view of a configuration and an optical path is shown in FIG. 7, aberration diagrams are shown in FIG. 8, and a lateral aberration diagram is shown in FIG. 9. In regard to the observation optical system 5 of Example 3, basic lens data is shown in Table 9, variable surface distances are shown in Table 10, specifications are shown in Table 11, and aspheric coefficients are shown in Table 12.

TABLE 9
Example 3

| Sn | R | D | Nd | νd |
|---|---|---|---|---|
| 1 | ∞ | 0.7000 | 1.51680 | 64.20 |
| 2 | ∞ | 4.3000 | | |
| 3 | ∞ | 0.5000 | 1.49023 | 57.49 |
| 4 | ∞ | dd[4] | | |
| *5 | 42.3900 | 6.0000 | 1.73000 | 55.00 |
| *6 | −10.9833 | 0.9944 | | |
| *7 | −10.4397 | 2.0983 | 1.68948 | 31.02 |
| *8 | 40.0815 | 0.9001 | | |
| *9 | 43.0283 | 8.8425 | 1.63230 | 59.88 |
| *10 | −11.9833 | dd[10] | | |
| 11 | ∞ | 1.2000 | 1.49023 | 57.50 |
| 12 | ∞ | 20.6000 | | |
| 13(EP) | ∞ | | | |

TABLE 10
Example 3

| Diopter | +2 dpt | −1 dpt | −4 dpt |
|---|---|---|---|
| dd[4] | 2.5532 | 1.5384 | 0.5236 |
| dd[10] | 0.9852 | 2.0000 | 3.0148 |

TABLE 11
Example 3

| | |
|---|---|
| fA | 17.16 |
| H | 12.81 |
| Finder | 0.83 |
| Magnification | |

TABLE 12
Example 3

| Sn | 5 | | 6 | |
|---|---|---|---|---|
| KA | 1.0000000E+00 | | 1.0000000E+00 | |
| A3 | −1.1861428E−04 | | 7.6654943E−05 | |
| A4 | −1.5861301E−05 | | 2.1292211E−04 | |
| A5 | −5.9580393E−05 | | −8.2176597E−05 | |
| A6 | 1.5625272E−05 | | 2.0216333E−05 | |
| A7 | −1.4947398E−06 | | −1.8972398E−06 | |
| A8 | −1.5590193E−07 | | −6.9349964E−08 | |
| A9 | −6.3861916E−09 | | −2.2661059E−08 | |
| A10 | 4.6034657E−09 | | 6.5489130E−09 | |
| A11 | −8.0493375E−11 | | 1.8478622E−10 | |
| A12 | −6.5592997E−11 | | 2.1377768E−12 | |
| A13 | 9.6124067E−12 | | −5.6211993E−12 | |
| A14 | 1.5079980E−12 | | −2.5420101E−13 | |
| A15 | −2.6005121E−14 | | −5.5311989E−14 | |
| A16 | −3.5918844E−14 | | 2.8423269E−15 | |
| A17 | −1.1490078E−15 | | −1.3915850E−16 | |
| A18 | 4.4197799E−17 | | 8.4020502E−17 | |
| A19 | 2.7174300E−18 | | 2.0061156E−17 | |
| A20 | 3.3240781E−18 | | −2.1682810E−18 | |
| Sn | 7 | 8 | 9 | 10 |
| KA | 1.0000000E+00 | 1.0000000E+00 | 1.0000000E+00 | 1.0000000E+00 |
| A4 | 4.3615015E−05 | −2.0827493E−06 | 3.2182451E−05 | 3.2975141E−05 |
| A6 | −2.6473691E−06 | 1.5588570E−06 | −7.0586880E−08 | 1.3760120E−07 |
| A8 | 5.7554797E−08 | −1.4878102E−08 | −2.1748428E−10 | 3.2318971E−09 |
| A10 | 1.9221272E−09 | −1.2314097E−10 | −4.9473924E−12 | −2.2134047E−11 |
| A12 | −1.6737736E−11 | −1.4547032E−12 | −3.9078466E−13 | −1.3438702E−13 |
| A14 | −6.8547955E−13 | 7.1265945E−14 | 1.9500532E−15 | 5.0198175E−15 |
| A16 | −6.0994352E−15 | −6.2218036E−16 | 6.6150477E−17 | −6.6093657E−18 |
| A18 | 4.1064370E−16 | 1.4048183E−18 | −6.5371577E−19 | −3.1112633E−19 |
| A20 | −3.2773775E−18 | 1.7234307E−21 | 1.6465746E−21 | 2.0029872E−21 |

Table 13 shows corresponding values of the conditional expressions (1) to (5) of the observation optical systems 5 of Examples 1 to 3. The values shown in Table 13 are values with respect to d line.

TABLE 13

| Expression | Conditional | Example | Example | Example |
|---|---|---|---|---|
| Number | Expression | 1 | 2 | 3 |
| (1) | H/fA | 0.7515 | 0.7546 | 0.7465 |
| (2) | TL/fA | 1.1337 | 1.1284 | 1.0977 |
| (3) | NdA | 1.771795 | 1.666083 | 1.681150 |
| (4) | f1/fA | 0.6505 | 0.7203 | 0.7311 |
| (5) | −f2/fA | 0.6442 | 0.7462 | 0.6884 |

From the above data, it can be understood that the observation optical systems 5 of Examples 1 to 3 satisfy the conditional expressions (1) to (5), and have a high finder magnification equal to or higher than 0.8 times while achieving reduction in size.

The present disclosure is not limited to the above-described embodiment and examples, and various modifications can be made. For example, the radius of curvature, the surface distance, the refractive index, the Abbe number, and the aspheric coefficient of each lens are not limited to the values shown in the above-described numerical examples, and may take other values.

Next, a camera 10 as an example of an optical apparatus including the observation optical system 5 according to the embodiment of the present disclosure will be described. The camera 10 according to the embodiment is an imaging apparatus that includes an electronic view finder (EVF) including the observation optical system 5 including the display element 1 and the eyepiece lens 3 of the present disclosure. The camera 10 has a function of correcting an image displayed on the display element 1 so as to reduce an influence of optical characteristics or the like of the observation optical system 5 on an image (that is, the image displayed on the display element 1) to be observed by the user through the observation optical system 5. With such image correction, the user can observe the image in which the influence due to the optical characteristics of the like of the observation optical system 5 is reduced. The optical characteristics of the observation optical system 5 include, as an example, a degree of fall of an amount of ambient light, or the like, in addition to aberrations, such as lateral chromatic aberration and distortion.

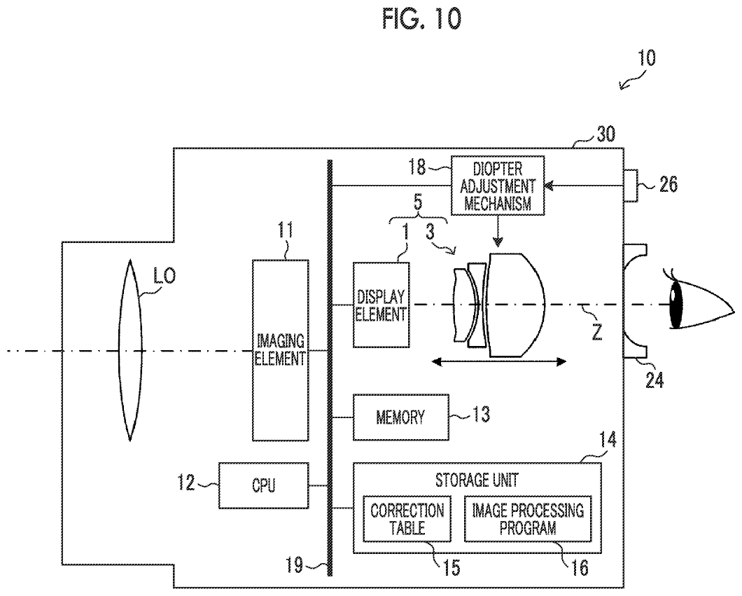

First, a hardware configuration of the camera 10 according to the embodiment will be described referring to FIG. 10. As shown in FIG. 10, the camera 10 comprises, inside a camera body 30, the observation optical system 5 of the present disclosure, an imaging lens LO, an imaging element 11, and a diopter adjustment mechanism 18. Furthermore, the camera 10 comprises an eye cup 24 and a diopter adjustment unit 26. The diopter adjustment unit 26 is a dial type operating unit for adjusting the diopter of the observation optical system 5. In addition, the camera 10 comprises a central processing unit (CPU) 12, a memory 13 as a temporary storage area, and a nonvolatile storage unit 14. The display element 1, the imaging element 11, the CPU 12, the memory 13, the storage unit 14, and the diopter adjustment mechanism 18 are connected to a bus 19.

In the camera 10, a subject image is formed on an imaging surface of the imaging element 11 by the imaging lens LO. The imaging element 11 outputs an image indicating the formed subject image. Various kinds of image correction are performed on the image captured by the imaging element 11, and an image after correction is displayed on the display element 1. The user looks into the EVF through the eye cup 24 and observes the image displayed on the display element 1 through the observation optical system 5. Furthermore, the diopter adjustment mechanism 18 moves a position of the eyepiece lens 3 in the direction of the optical axis Z according to a user's operation of the diopter adjustment unit 26. With this, it is possible to adjust a focus in conformity with the diopter of the user called nearsightedness or farsightedness.

The storage unit 14 is realized by a hard disk drive (HDD), a solid state drive (SSD), a flash memory, or the like. In the storage unit 14, a correction table 15 and an image processing program 16 are stored. The CPU 12 reads the image processing program 16 from the storage unit 14, then, develops the image processing program 16 to the memory 13, and executes the developed image processing program 16.

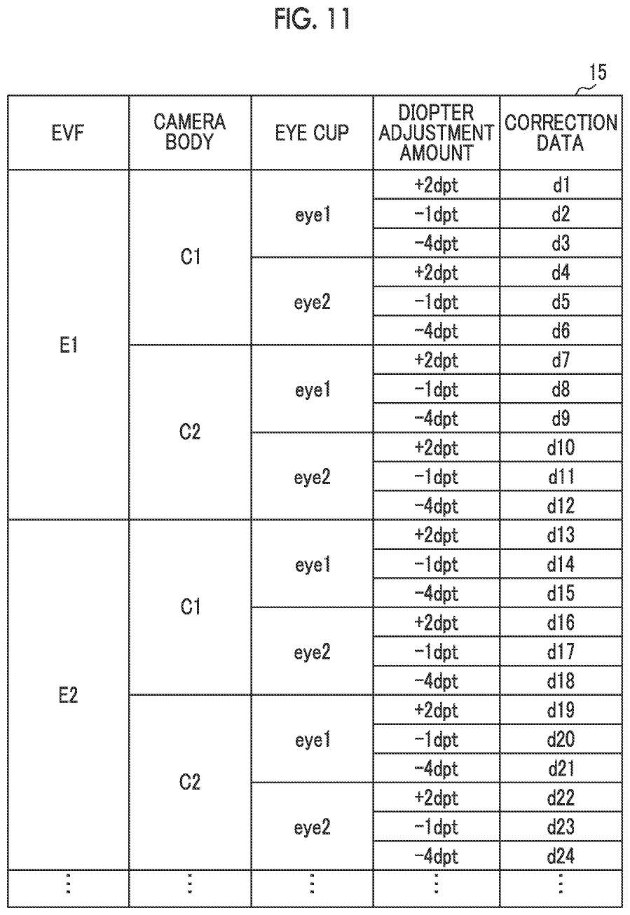

An example of the correction table 15 will be described referring to FIG. 11. In the correction table 15, correction data for correcting the image to be observed by the user through the observation optical system 5 is stored for each combination of the kind of the EVF in the camera 10, the kind of the camera body 30, the kind of the eye cup 24, and each condition of a diopter adjustment amount of the observation optical system 5.

In the example of FIG. 11, as an example of the kind of the EVF, E1 and E2 are exemplified. The EVFs, such as E1 and E2, are different in, for example, optical characteristics of the observation optical system 5 included in each EVF.

In the example of FIG. 11, as an example of the kind of the camera body 30, C1 and C2 are exemplified. In each camera body 30, such as C1 or C2, the imaging lens LO is different. In a case where the imaging lens LO is different, optical characteristics including aberrations of the imaging lens LO are different. In the optical characteristics of the imaging lens LO, like the optical characteristics of the observation optical system 5, as an example, a degree of fall of an amount of ambient light, or the like is included in addition to aberrations, such as lateral chromatic aberration and distortion. In the camera 10, since the image displayed on the display element 1 is an image acquired through the imaging lens LO and the imaging element 11, the optical characteristics of the imaging lens LO also have an influence on the image displayed on the display element 1. In this way, the image to be observed by the user through the observation optical system 5 receives an influence due to the optical characteristics of the imaging lens LO, in addition to the influence due to the optical characteristics of the observation optical system 5.

In the example of FIG. 11, as an example of the kind of the eye cup 24, eye1 and eye2 are exemplified. The eye cups 24, such as eye1 and eye2, are different in thickness in the direction of the optical axis Z of the observation optical system 5 and in size of an opening for allowing the user to look into the EVF. With the differences, the appearance of distortion, lateral chromatic aberration, or the like in the image to be observed by the user through the observation optical system 5, the degree of fall of the amount of ambient light, and the like also change. In this way, the image to be observed by the user through the observation optical system 5 receives an influence due to the kind of the eye cup 24, in addition to the influence due to the optical characteristics of the observation optical system 5.

In the example of FIG. 11, as an example of the diopter adjustment amount, +2 dpt, −1 dpt, and −4 dpt are exemplified. In a case where the diopter adjustment amount changes, since the position of the eyepiece lens 3 with respect to the display element 1 changes, for example, a path of a ray with respect to the observation optical system 5 changes. With the change, the way of appearance of distortion, lateral chromatic aberration, or the like in the image to be observed by the user through the observation optical system 5, the degree of fall of the amount of ambient light, and the like also change. In this way, the image to be observed by the user through the observation optical system 5 receives an influence due to the diopter adjustment amount, in addition to the influence due to the optical characteristics of the observation optical system 5.

As described above, the image to be observed by the user through the observation optical system 5 receives an influence according to each condition. Accordingly, the way of appearance of distortion, lateral chromatic aberration, or the like, the degree of fall of the amount of ambient light, and the like also change for each combination of the conditions. Therefore, in the correction table 15 according to the embodiment, correction data that is different for each combination of the conditions and can suitably correct the image to be observed by the user through the observation optical system 5 is stored. The correction data is data that defines how to change a pixel value for each pixel of an image to be corrected in order to reduce aberrations, such as distortion and lateral chromatic aberration, the fall of the amount of ambient light, and the like.

In the example of FIG. 11, as an example of the correction data, d1 to d24 are exemplified. For example, the correction data d1 is correction data in a case where the conditions that the EVF is E1, the camera body 30 is C1, the eye cup 24 is eye1, and the diopter adjustment amount is “+2 dpt” are combined.

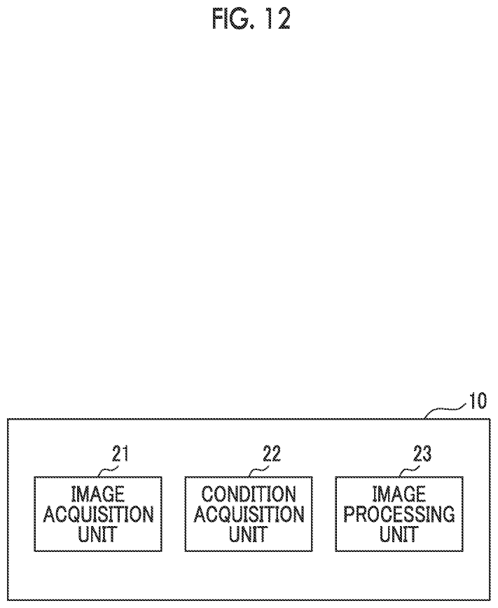

A functional configuration of the camera 10 according to the embodiment will be described referring to FIG. 12. As shown in FIG. 12, the camera 10 includes an image acquisition unit 21, a condition acquisition unit 22, and an image processing unit 23. The CPU 12 executes the image processing program 16, thereby functioning as the image acquisition unit 21, the condition acquisition unit 22, and the image processing unit 23.

The image acquisition unit 21 acquires an image output from the imaging element 11. The condition acquisition unit 22 acquires information relating to the conditions defined in the correction table 15. Information relating to the conditions of the kind (E1, E2, and the like) of the EVF, the kind (C1, C2, and the like) of the camera body, and the kind (eye1, eye2, and the like) of the eye cup are stored in the storage unit 14 in advance, for example, at the time of manufacturing of the camera 10. In regard to information relating to the condition of the diopter adjustment amount, for example, a current value set by user's adjustment is stored in the storage unit 14. In this case, the condition acquisition unit 22 acquires information relating to a combination of the conditions from the storage unit 14.

The image processing unit 23 reads, based on each condition acquired by the condition acquisition unit 22, the correction data corresponding to the condition from the correction table 15, and performs image correction on the image based on the read correction data. The image processing unit 23 outputs an image after correction to the display element 1. The image after correction is displayed on the display element 1. The image processing unit 23 may execute various kinds of image processing, such as white balance correction, brightness correction, and contrast adjustment, on the image.

As described above, the camera 10 according to the embodiment performs image correction to reduce the influence on the image due to the optical characteristics of the observation optical system 5 and the like on an image generated based on the image acquired by the imaging element 11, and then, displays the image after correction on the display element 1. Image correction is performed based on correction data in consideration of a factor having an influence on the image to be observed by the user through the observation optical system 5. The correction data that is used for image correction is selected according to a combination of selected conditions among a plurality of conditions including a condition that defines the optical characteristics of the observation optical system 5, a condition that defines the optical characteristics of the imaging lens LO, the kind of the eye cup 24, and the diopter adjustment amount. Accordingly, even in the camera 10 including the observation optical system 5 in which both of reduction in size and a high finder magnification are achieved, it is possible to suitably correct an influence on an image due to the optical characteristics of the observation optical system 5, and the like according to various elements configuring the camera 10.

The above-described correction table 15 is an example, and various modifications can be made. For example, a form may be made in which any conditions among the above-described conditions are selectively used or a form may be made in which other conditions are used.

For example, in a case where the eye cup 24 is attachable and detachable to and from the camera body 30, and the user can select whether or not to use the eye cup 24, the correction data may be varied according to the presence or absence of the eye cup 24. In this case, for example, information regarding the presence or absence of the eye cup 24 may be input by the user through an input unit (not shown) in the camera 10, and the input information may be stored in the storage unit 14 as a condition of the eye cup 24.

The kind of the eye cup 24 and the presence or absence of the eye cup 24 are an example of a condition that defines the position of the eye point EP of the observation optical system 5. Accordingly, in addition to or instead of this, a mechanism that acquires the position of the eye point EP may be provided in the camera 10, and the position of the eye point EP acquired through the mechanism may be used as a condition for selecting the correction data. As the mechanism that acquires the position of the eye point EP, for example, a mechanism that receives an input by a user's manual operation, such as the input unit of the camera 10, may be used. A sensor that optically detects a pupil position of the user may be provided in an eyepiece portion or the like of the camera body 30, and the sensor may be used as the mechanism that acquires the position of the eye point EP.

The diopter adjustment amount is an example of a condition that defines the diopter of the observation optical system 5. Accordingly, in addition to or instead of this, a diopter of a diopter adjustment lens in a case where an attachable and detachable diopter adjustment lens is mounted may be used as a condition for selecting the correction data. In this case, for example, information regarding the diopter of the diopter adjustment lens may be input by the user through the input unit (not shown) in the camera 10, and the input information may be stored in the storage unit 14 as the condition for the diopter of the diopter adjustment lens.

The hardware configuration of the camera 10 shown in FIG. 10 is an example, and the observation optical system 5 in the camera 10 may comprise the optical members 2 and 4. An imaging optical system may comprise a stop, a mechanism that controls the imaging lens LO and the stop, and the like. A configuration may be made in which the diopter adjustment mechanism 18, the eye cup 24, the diopter adjustment unit 26, and the like are excluded. In FIG. 10, although an example of a finder incorporated in the camera 10 has been shown, the present disclosure can also be applied to an external finder.

In the embodiment, for example, as the hardware structures of processing units that execute various kinds of processing, such as the image acquisition unit 21, the condition acquisition unit 22, and the image processing unit 23, various processors described below can be used. Various processors include a programmable logic device (PLD) that is a processor capable of changing a circuit configuration after manufacture, such as a field programmable gate array (FPGA), a dedicated electric circuit that is a processor having a circuit configuration dedicatedly designed for executing specific processing, such as an application specific integrated circuit (ASIC), and the like, in addition to a CPU that is a general-purpose processor executing software (program) to function as various processing units, as described above.

One processing unit may be configured of one of various processors described above or may be configured of a combination of two or more processors (for example, a combination of a plurality of FPGAs or a combination of a CPU and an FPGA) of the same type or different types. A plurality of processing units may be configured of one processor. As an example where a plurality of processing units are configured of one processor, first, as represented by a computer, such as a client or a server, there is a form in which one processor is configured of a combination of one or more CPUs and software, and the processor functions as a plurality of processing units. Secondly, as represented by system on chip (SoC) or the like, there is a form in which a processor that implements all functions of a system including a plurality of processing units into one integrated circuit (IC) chip is used. In this way, various processing units may be configured using one or more processors among various processors described above as a hardware structure.

In addition, as the hardware structure of various processors, more specifically, an electric circuit (circuitry), in which circuit elements, such as semiconductor elements, are combined can be used.

From the above description, it is possible to ascertain an optical apparatus described in the following supplementary item.

Supplementary Item 1

An optical apparatus including:

an imaging element that outputs an image indicating a subject formed by an imaging lens;

an observation optical system including a display element that displays the image output from the imaging element, and an eyepiece lens through which the image displayed on the display element is observed; and

a processor that performs image correction on the image displayed on the display element,

wherein the processor is configured to

perform the image correction on the image displayed on the display element based on correction data in consideration of a factor having an influence on the image observed by a user through the observation optical system and according to a combination of selected conditions among a condition for defining an optical characteristic of the observation optical system, a condition for defining an optical characteristic of the imaging lens, and a plurality of conditions including a kind of an eye cup and a diopter adjustment amount.

The observation optical system 5 of the present disclosure is not applied only to the camera 10 according to the embodiment, and may be applied to, for example, an optical apparatus not including processing of correcting an image displayed on the display element 1. Furthermore, the observation optical system 5 of the present disclosure can also be applied to an optical apparatus, such as a film camera, a video camera, and a head-mounted display.

What is claimed is:

1. An observation optical system comprising:
a display element; and
an eyepiece lens disposed on an eye point side of the display element,
wherein the eyepiece lens consists of, in order from a display element side toward the eye point side,
a first lens having a positive refractive power,
a second lens having a negative refractive power, and
a third lens having a positive refractive power, and
in a case where a longest diameter of a display area in the display element is H, and a focal length of the eyepiece lens is fA, a conditional expression (1) is satisfied:
0.7<H/fA<0.8 (1).

2. The observation optical system according to claim 1, wherein, in a case where a distance on an optical axis from a display element-side surface of the first lens to an eye point-side surface of the third lens is TL, a conditional expression (2) is satisfied:
1.075<TL/fA<1.16 (2).

3. The observation optical system according to claim 1, wherein, in a case where an average value of a refractive index of the first lens with respect to d line and a refractive index of the third lens with respect to d line is NdA, a conditional expression (3) is satisfied:
1.64<NdA<1.8 (3).

4. The observation optical system according to claim 1, wherein, in a case where a focal length of the first lens is f1, a conditional expression (4) is satisfied:
0.63<f1/fA<0.75 (4).

5. The observation optical system according to claim 1, wherein, in a case where a focal length of the second lens is f2, a conditional expression (5) is satisfied:
0.62<−f2/fA<0.77 (5).

6. The observation optical system according to claim 1, wherein each of the first lens, the second lens, and the third lens is a single lens.

7. The observation optical system according to claim 1, wherein the first lens is a biconvex lens.

8. The observation optical system according to claim 1, wherein the second lens is a biconcave lens.

9. The observation optical system according to claim 1, wherein the third lens is a biconvex lens.

10. The observation optical system according to claim 1, wherein at least one surface of the first lens is an aspheric surface.

11. The observation optical system according to claim 1, wherein at least one surface of the second lens is an aspheric surface.

12. The observation optical system according to claim 1, wherein at least one surface of the third lens is an aspheric surface.

13. The observation optical system according to claim 1, wherein a conditional expression (1-1) is satisfied:
0.72<H/fA<0.78 (1-1).

14. The observation optical system according to claim 1, wherein a conditional expression (1-2) is satisfied:
0.735<H/fA<0.77 (1-2).

15. The observation optical system according to claim 2, wherein a conditional expression (2-1) is satisfied:
1.085<TL/fA<1.15 (2-1).

16. The observation optical system according to claim 3, wherein a conditional expression (3-1) is satisfied:
1.65<NdA<1.79 (3-1).

17. The observation optical system according to claim 4, wherein a conditional expression (4-1) is satisfied:
0.64<f1/fA<0.74 (4-1).

18. The observation optical system according to claim 5, wherein a conditional expression (5-1) is satisfied:
0.63<−f2/fA<0.76 (5-1).

19. An optical apparatus comprising: the observation optical system according to claim 1.
